(19) United States
(12) Patent Application Publication
(10) Pub. No.: US 2012/0210839 A1
(43) Pub. Date: Aug. 23, 2012

(54) CUTTING APPARATUS

(75) Inventor: Yasuhisa KOSEKI, Shinagawa-ku (JP)

(73) Assignee: HIRATA CORPORATION, Shinagawa-ku (JP)

(21) Appl. No.: 13/399,540

(22) Filed: Feb. 17, 2012

(30) Foreign Application Priority Data
Feb. 22, 2011 (JP) 2011-036308

(51) Int. Cl. B26D 7/01; B26D 7/18; B26D 1/10

(52) U.S. Cl. 83/167; 83/409; 83/732

(57) ABSTRACT

A cutting apparatus cuts the edge portions of a cover sheet covering a rectangular substrate. This cutting apparatus includes a holding unit, a head unit, a first moving unit, and a second moving unit. The holding unit holds the rectangular substrate by chucking one surface of the rectangular substrate. The head unit includes a cutting unit which cuts an edge portion of the cover sheet and a pivot unit which makes the cutting unit pivot to change a cutting direction. The first moving unit moves the head unit in a first direction parallel to one side of the rectangular substrate. The second moving unit moves the holding unit in a second direction perpendicular to the one side of the rectangular substrate, and moves the holding unit across a transfer position of the rectangular substrate and a cutting operation region which are continuous in the second direction.

### BACKGROUND OF THE INVENTION

1. Field of the Invention

The present invention relates to a technique of cutting a cover sheet (wrapping sheet) which covers a substrate.

2. Description of the Related Art

In some cases, a cover sheet covers a substrate such as a glass substrate or a semiconductor wafer to protect its surface. For example, a solar cell module substrate uses a cover sheet to protect the light-receiving surface and binds a plurality of members formed in a multilayer form which constitute the substrate.

The edge portions of the cover sheet which protrude from the periphery of a substrate are not necessary, and hence it is necessary to cut them. Under the circumstances, cutting apparatuses which cut the edge portions of cover sheets have been proposed (Japanese Patent Publication No. 7-49189 and Japanese Patent Laid-Open Nos. 2001-320069 and 2001-135840).

When cutting the edge portion of a cover sheet which covers a rectangular substrate, it is necessary to cut the cover sheet along the four sides of the rectangular substrate. This generally requires a mechanism of moving a cutting unit in two directions perpendicular to each other. This also requires a mechanism of moving a substrate to a position suitable for cutting by the cutting unit. For this reason, the apparatus tends to increase in complexity and size.

### SUMMARY OF THE INVENTION

It is an object of the present invention to provide a cutting apparatus which can cut a cover sheet along the four sides of a rectangular substrate with a simpler arrangement.

According to the present invention, there is provided a cutting apparatus which cuts an edge portion of a cover sheet covering a rectangular substrate, comprising: a holding unit which holds the rectangular substrate by chucking one surface of the rectangular substrate; a head unit including a cutting unit which cuts an edge portion of the cover sheet and a pivot unit which makes the cutting unit pivot to change a cutting direction; a first moving unit which moves the head unit in a first direction parallel to one side of the rectangular substrate; and a second moving unit which moves the holding unit in a second direction parallel to the other side perpendicular to the one side of the rectangular substrate, and moves the holding unit across a transfer position of the rectangular substrate and a cutting operation region which are continuous in the second direction.

Further features of the present invention will become apparent from the following description of exemplary embodiments (with reference to the attached drawings).

### BRIEF DESCRIPTION OF THE DRAWINGS

FIG. 1 is a plan view of a cutting apparatus according to an embodiment of the present invention;

FIG. 2 is a front view of the cutting apparatus;

FIG. 3 is an exploded perspective view of the cutting apparatus;

FIG. 4 is a block diagram of a controller; and

FIGS. 5 to 13 are views for explaining the operation of the cutting apparatus.

### DESCRIPTION OF THE EMBODIMENTS

<Outline of Apparatus>

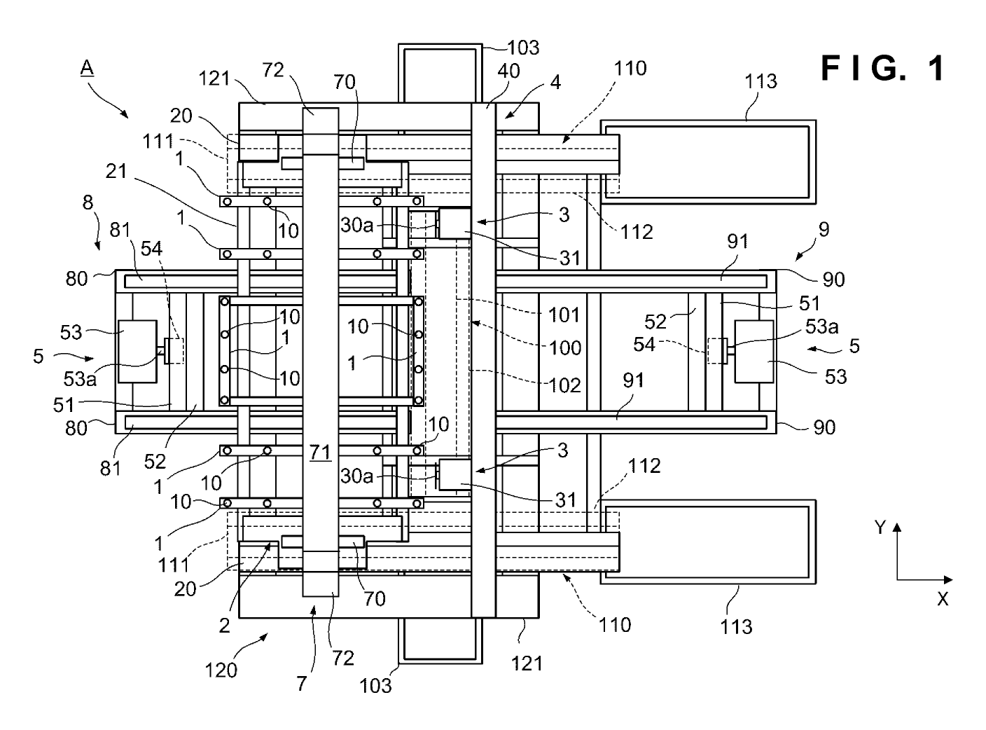

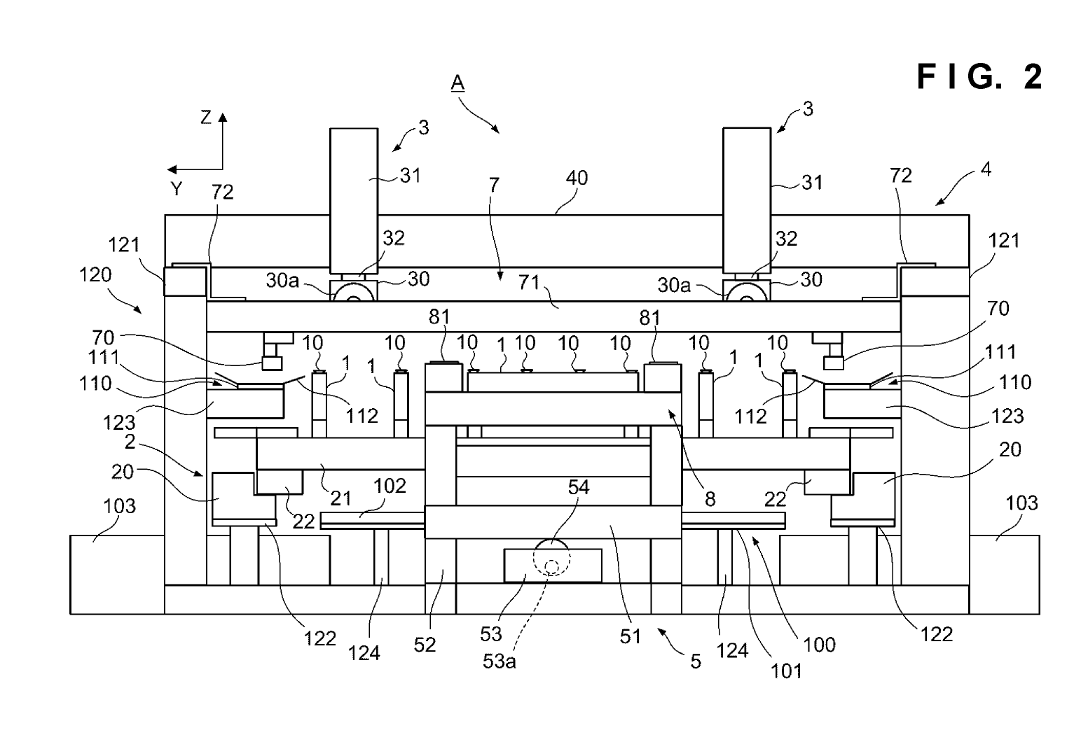

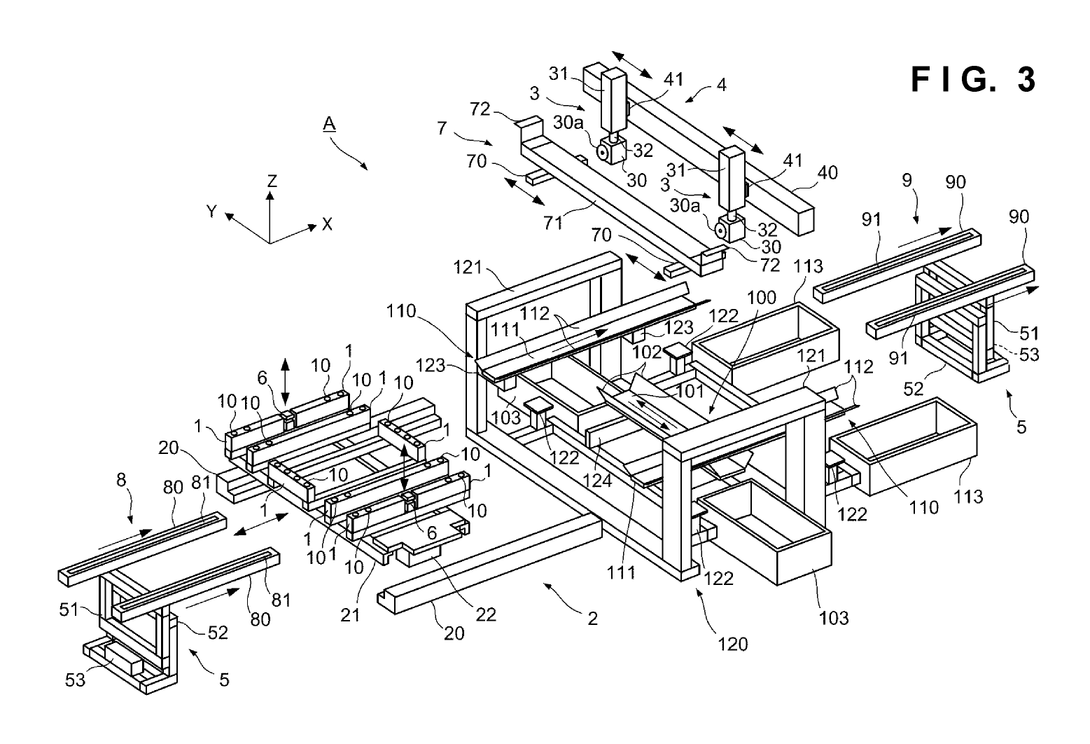

FIG. 1 is a plan view of a cutting apparatus A according to an embodiment of the present invention. FIG. 2 is a front view of the cutting apparatus A. FIG. 3 is an exploded perspective view of the cutting apparatus A. Note that collection units 100 and 110 indicated by the broken lines in FIG. 1 are shown in a perspective view. In each drawing, arrows X and Y respectively indicate two directions perpendicular to each other in the horizontal direction, and an arrow Z indicates the vertical direction. In this embodiment, the X direction coincides with the conveying direction of a substrate conveyed by convey units 8 and 9 (to be described later).

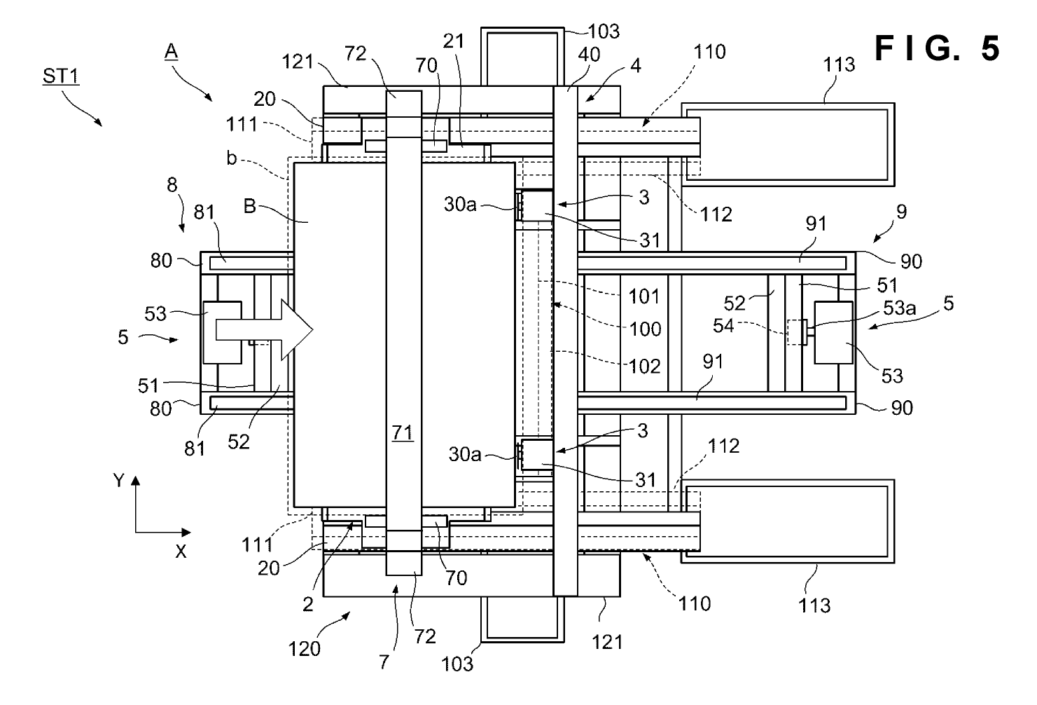

The cutting apparatus A includes holding units 1, a moving unit 2, head units 3, a moving unit 4, convey/lifting units 5, substrate lifting units 6, a positioning unit 7, the convey units 8 and 9, and the collection units 100 and 110. As will be described later, the cutting apparatus A is an apparatus which cuts the edge portions (the portions protruding from the periphery of a rectangular substrate B (see FIG. 5)) of a cover sheet b (see FIG. 5) which covers the substrate B.

<Holding Unit 1>

The holding units 1 hold the substrate B by chucking its one surface (the lower surface of the substrate in this embodiment). This embodiment is provided with a plurality of holding units 1, each of which includes a plurality of vacuum-chucking pads 10 which chuck one surface of the substrate B. All the vacuum-chucking pads 10 are positioned on the common X-Y plane (horizontal plane) and can hold a substrate in a horizontal posture. Each vacuum-chucking pad 10 is connected to a vacuum pump (not shown). When this vacuum pump is operated, the vacuum-chucking pads 10 chuck and hold a substrate.

In this embodiment, the holding units 1 are arranged along the four sides of the substrate B to hold the periphery of the substrate B. Holding the periphery of the substrate B can prevent the periphery of the substrate from swinging when cutting the cover sheet b. This makes it possible to properly cut the edge portions of the cover sheet b. Note that the holding unit 1 may be disposed to hold a central portion of the substrate B.

<Moving Unit 2>

The moving unit 2 includes a pair of guide members 20, a moving body 21 laid between the pair of guide members 20, and driving units 22.

The pair of guide members 20 are spaced apart from each other in the Y direction and extend parallel to the X direction. The moving body 21 has a frame-like shape, on which the plurality of holding units 1 are mounted and supported. The driving units 22 are provided on the lower surfaces of the two end portions of the moving body 21, and sliders which respectively engage with the guide members 20 to be guided by them when moving. That is, the driving units 22 constitute a moving mechanism which moves the moving body 21 along the pair of guide members 20.

As this moving mechanism, for example, a ball screw mechanism can be used. When using a ball screw mechanism, it is possible to use an arrangement in which the guide members 20 include ball screw shafts extending in the X direction, and the driving units 22 include ball nuts which threadably engage with the ball screw shafts and motors (for example, hollow motors) which rotate the ball nuts. In this arrangement, synchronously driving the motors of the driving units 22 can translate the moving body 21 in the X direction (the transfer direction of a substrate). Other moving mechanisms which can be used include a rack-pinion mechanism, a toothed belt-pulley mechanism, and a linear mechanism.

Note that one of the two driving units 22 can be configured to be simply driven along the guide member 20 without providing any drive source such as a motor.

The moving unit 2 moves the moving body 21 in the X direction to move the holding units 1 mounted on the moving body 21 across a transfer position and a cutting operation region which are continuous in the X direction. In this embodiment, the transfer position includes a load position (the lower left position in FIG. 3) on one end portion of the guide members 20 and an unload position (the upper right position in FIG. 3) on the other end portion, and the cutting operation region is the region between the load position and the unload position. That is, in this embodiment, the cutting operation region is set to the entire moving range of the holding units 1, and its two end portions are set to the load and unload positions. This has the effect of shortening the total length of the cutting apparatus A.

The load position is set on one of the two end portions of the guide members 20 which is located on the convey unit 8 side (one end portion side). At this position, the convey unit 8 loads the substrate B (on which the edge portions of the cover sheet b are not cut yet) onto the holding units 1. The unload position is set on one of the two end portions of the guide members 20 which is located on the convey unit 9 side (the other end portion). At this position, the substrate B (on which the edge portions of the cover sheet b have already been cut) is unloaded from the holding units 1 to the convey unit 9.

<Head Unit 3>

The head units 3 include cutting units 30 which cut the edge portions of the cover sheet b and lifting/pivoting units 31 which move the cutting units 30 and change the cutting directions by making them pivot (rotate). This embodiment includes two head units 3. This can simultaneously cut edge portions of the cover sheet b at different positions, thereby improving the cutting efficiency. Obviously, the embodiment may include only one head unit 3.

Each cutting unit 30 includes a disc blade 30a and a driving mechanism such as a motor which rotates the disc blade 30a. The cutting unit 30 cuts an edge portion of the cover sheet b by rotating the disc blade 30a. This embodiment uses, as the cutting unit 30, a mechanism for cutting the cover sheet b by rotating the disc blade 30a. However, the mechanism to be used is not limited to this. The embodiment can use other types of cutting mechanisms, for example, a mechanism for cutting the cover sheet b with a fixed blade and a mechanism for cutting the cover sheet b with a laser beam.

The lifting/pivoting units 31 include mechanisms (not shown) for rotating shaft bodies 32 about their shaft centers (Z direction) and vertically moving the shaft bodies 32. In this embodiment, the cutting units 30 are coupled to the shaft bodies 32. The lifting/pivoting units 31 make the cutting units 30 pivot by rotating the shaft bodies 32 and can maintain their pivot angles. In addition, the lifting/pivoting units 31 can vertically move the cutting units 30 in the Z direction by vertically moving the shaft bodies 32.

Changing the cutting directions by making the cutting units 30 pivot can cut the edge portions of the cover sheet b along the four sides of the substrate B. In addition, it is possible to adjust the direction of the disc blade 30a relative to each side of the substrate B. More specifically, it is possible to adjust the angle (intersection angle) between a plane perpendicular to the substrate surface of the substrate B (a plane perpendicular to the Z direction in this embodiment) and a plane formed by the disc blade 30a (a plane perpendicular to the Z direction in this embodiment). Adjusting this angle and maintaining it can make the disc blade 30a abut against the periphery of the substrate B at a proper angle. This can prevent the periphery of the substrate B from being damaged at the time of cutting of a cover sheet.

In addition, vertically moving each cutting unit 30 can adjust the cutting blade position (height position) of the disc blade 30a relative to a plane perpendicular to a direction parallel to a direction normal to the substrate surface of the substrate B (a plane perpendicular to the Z direction in this embodiment) and a plane formed by the disc blade 30a (a plane perpendicular to the Z direction in the embodiment).

A known mechanism can be used as a mechanism for rotating and vertically moving the shaft body 32. For example, as a mechanism for rotating the shaft body 32, there is available a combination of a drive source such as a motor and a mechanism such as a gear mechanism or a belt mechanism. As a mechanism for maintaining the rotational angle of the shaft body 32, for example, it is possible to use the electromagnetic lock function of a servo motor when the servo motor is used as a drive source. Alternatively, it is possible to separately provide a lock mechanism for releasably restricting the rotation of the shaft body 32. As a mechanism for vertically moving the shaft body 32, there is available a combination of a drive source such as a motor and a mechanism such as a rack-pinion mechanism.

<Moving Unit 4>

The moving unit 4 moves the head units 3 in the Y direction. In this embodiment, the moving unit 4 includes an guide member 40, moving bodies 41 attached to the guide member 40 so as to allow them to move along the guide member 40, and a moving mechanism (not shown) for moving the moving bodies 41 along the guide member 40.

The guide member 40 extends in the Y direction. The two moving bodies 41 are provided in correspondence with the number of head units 3, and are sliders which engage with the guide member 40 and move while being guided by it. In this embodiment, the guide member 40 is common to the two moving bodies 41. This can simplify the arrangement as compared with a case in which the guide member 40 is provided for each moving body 41.

As a moving mechanism (not shown), for example, a ball screw mechanism is available. When using a ball screw mechanism, it is possible to use an arrangement in which the guide member 40 includes a ball screw shaft extending in the Y direction, and each moving body 41 is provided with a ball nut which threadably engages with the ball screw shaft and a motor (for example, a hollow motor) which rotates the ball nut.

Since each moving body 41 includes a motor, it is possible to independently move and control the moving bodies 41. This makes it possible to independently move and control the two head units 3. Note that one ball screw shaft may be commonly provided for the two moving bodies 41, or may be provided for each moving body 41.

In this embodiment, the moving unit 4 is disposed so as to be vertically shifted from the holding units 1 within the moving range of the holding units 1 moved by the moving unit 2. In particular, the guide member 40 is disposed in a direction to separate from the guide members 20 vertically and intersect them. According to this arrangement, since the guide members 20 and 40 can be stacked vertically, the installation space can be effectively used. In addition, since it is possible to make the width of the moving unit 2 fall within the range of the guide member 40 in the longitudinal direction, it is possible to achieve space saving.

<Convey/Lifting Unit 5>

The convey/lifting units 5 each are provided to support one end portion (an end portion on the side opposite to the holding units 1) of a corresponding one of belt conveyors 80 and 90 of the convey units 8 and 9, and vertically move a corresponding one of the convey units 8 and 9 at the transfer position relative to the holding units 1. This can transfer the substrate B between the holding units 1 and the convey units 8 and 9. In this embodiment, the convey/lifting units 5 include support frames 51 which support the convey units 8 and 9 and guide frames 52 which support the support frames 51 so as to allow them to move in the Z direction. The guide frames 52 are provided with rail members extending in the Z direction. The support frames 51 are provided with sliders which engage with the rail members and slide in the Z direction.

The convey/lifting units 5 include motors 53 and eccentric cams 54 provided on output shafts 53a of the motors 53. The circumferential surfaces of the eccentric cams 54 are in contact with the lower surfaces of the support frames 51. Rotating the eccentric cams 54 can vertically move the support frames 51 in the Z direction. This makes it possible to vertically move the convey units 8 and 9.

In this embodiment, the cam mechanisms using the motors 53 as drive sources vertically move the convey units 8 and 9. However, it is possible to use air cylinders as drive sources and various types of mechanisms as mechanisms using them.

This embodiment is configured to vertically move the convey units 8 and 9. However, it is possible to vertically move the holding units 1. That is, it is possible to move either the holding units 1 or the convey units 8 and 9 as long as it is possible to vertically move them relatively to each other.

<Substrate Lifting Unit 6>

The substrate lifting units 6 vertically move the substrate B relative to the holding units 1. In this embodiment, when the convey unit 8 loads a substrate onto the holding units 1, the positioning unit 7 positions the substrate B. When positioning the substrate B, the substrate lifting units 6 move upward to separate the substrate B from the vacuum-chucking pads 10 of the holding units 1. Upon completion of positioning of the substrate B, the substrate lifting units 6 move the substrate B downward to mount it on the vacuum-chucking pads 10 of the holding units 1 and cause the vacuum-chucking pads 10 to hold the substrate. In this embodiment, the substrate lifting units 6 are air cylinders. However, other driving mechanisms can be used.

<Positioning Unit 7>

The positioning unit 7 positions the substrate B in the Y direction at the load position. The positioning unit 7 includes a pair of abutment members 70 spaced apart from each other in the Y direction, a guide member 71 which supports the pair of abutment members 70 so as to allow them to move in the Y direction, and a moving mechanism (not shown) which moves the pair of abutment members 70. The moving mechanism can be constituted by, for example, a drive source such as an air cylinder which moves one of the abutment members 70 and a link mechanism which interlocks the two abutment members 70.

The pair of abutment members 70 are moved between the positioning positions at which the abutment members abut against two sides of the substrate B which face each other in the Y direction to position the substrate B and retreat positions at which the abutment members are spaced apart from each other more than at the positioning positions. The pair of abutment members 70 are plate-like members extending in the Y direction, and hence abut against two sides of the substrate B which face each other so as to position the substrate in the Y direction and to adjust the posture of the substrate B by making the two sides of the substrate B which face each other parallel to the Y direction while making the remaining two sides parallel to the X direction. This makes the moving unit 4 move the head units 3 in the Y direction relative to the substrate B along sides of the substrate B, and also makes the moving unit 2 move the holding units 1 in the X direction to move the head units 3 relative to the substrate B along sides of the substrate B.

<Convey Units 8 and 9>

In this embodiment, both the convey units 8 and 9 are regarded as the belt conveyors 80 and 90 which respectively make endless belts 81 and 91 run in the X direction. In the embodiment, two rows of each of the belt conveyors 80 and 90 are spaced apart from each other in the Y direction. The substrate B is disposed on the endless belts 81 and 91 to be conveyed. The convey unit 8 is used to load the substrate B. The convey unit 9 is used to unload the substrate B. In this embodiment, the convey units 8 and 9 are regarded as belt conveyors. However, it is possible to use other types of convey apparatuses such as roller conveyors or multijoint robots. In addition, the embodiment includes both the convey units for loading and unloading. However, it is possible to use one of them.

As described above, the convey units 8 and 9 each have a cantilever structure. That is, only one end portion of each convey unit is supported, while the other end portion (the end portion on the holding unit 1 side) has no support structure. This allows the other end portion side of each of the convey units 8 and 9 to be overlapped (superimposed), in the X direction, on the holding units 1 extending in the X direction. More specifically, the convey units 8 and 9 are provided while the other end portion side of each of the convey units 8 and 9 enters a frame member 120 (to be described later). This makes it possible to transfer the substrate B between the convey units 8 and 9 and the holding units 1.

<Collection Units 100 and 110>

The collection units 100 and 110 collect the cut edge portions of the cover sheet b. This can prevent the cut edge portions of the cover sheet b from being scattered.

In this embodiment, the collection unit 100 includes a belt conveyor 101 disposed below the moving path of the cutting unit 30 along the guide member 40 and a pair of guide members 102 disposed on the two side portions of the belt conveyor 101.

The belt conveyor 101 extends in the Y direction and includes an endless belt which runs in the Y direction. The pair of guide members 102 are obliquely disposed so as to open upward (increase in interval). Collection boxes 103 are respectively disposed on the two end portions (the two end portions in the Y direction) of the belt conveyor 101. When the cutting units 30 cut edge portions of the cover sheet b along the two ends of the substrate B in the X direction, the cut edge portions drop on the belt conveyor 101. When the edge portions drop, the pair of guide members 102 function as chutes (slides) which guide the edge portions onto the belt conveyor 101. The belt conveyor 101 is operated continuously or periodically to make the endless belt run, thereby conveying the cut edge portions to the collection boxes 103.

The collection units 110 are respectively provided along the pair of guide members 20 below the cutting units 30. Each collection unit 110 includes a belt conveyor 111 and a pair of guide members 112 provided on the two side portions of the belt conveyor 111.

The belt conveyor 111 extends in the X direction and includes an endless belt which runs in the X direction. The pair of guide members 112 are obliquely disposed so as to open such that the interval between them increases upward. A collection box 113 is disposed on one end portion (one end portion in the transfer direction) of the belt conveyor 111. When the cutting units 30 cut edge portions of the cover sheet b along the two sides of the substrate B in the Y direction, the cut pieces drop on the belt conveyor 111. When the cut pieces drop, the pair of guide members 112 guide the cut pieces onto the belt conveyor 111. The belt conveyor 111 is operated continuously or periodically to make the endless belt run, thereby conveying the cut pieces to the collection boxes 113.

Note that this embodiment uses the belt conveyors 101 and 111 as the collection units 100 and 110. However, it is possible to use other arrangements. For example, the embodiment may use an arrangement including trough-like (almost U-shaped) member which receives cut pieces which are cut and drop and a suction device which sucks cut pieces in the trough and discharges them into the collection box.

<Frame Member 120>

The guide members 20, the guide member 40, and collection units 100 and 110 are all integrally supported on the common frame member 120. Supporting them with the common frame member 120 can improve the positioning accuracy between them.

The guide member 40 is laid between a pair of beam portions 121 of the frame member 120. The pair of beam portions 121 are spaced apart from each other in the Y direction, and each extends in the X direction. The guide members 20 are mounted and supported on support portions 122 of the frame member 120. As shown in FIG. 2, the collection unit 100 is mounted and supported on support portions 124 of the frame member 120. Each collection unit 110 is mounted and supported on support portions 123 of the frame member 120.

<Controller>

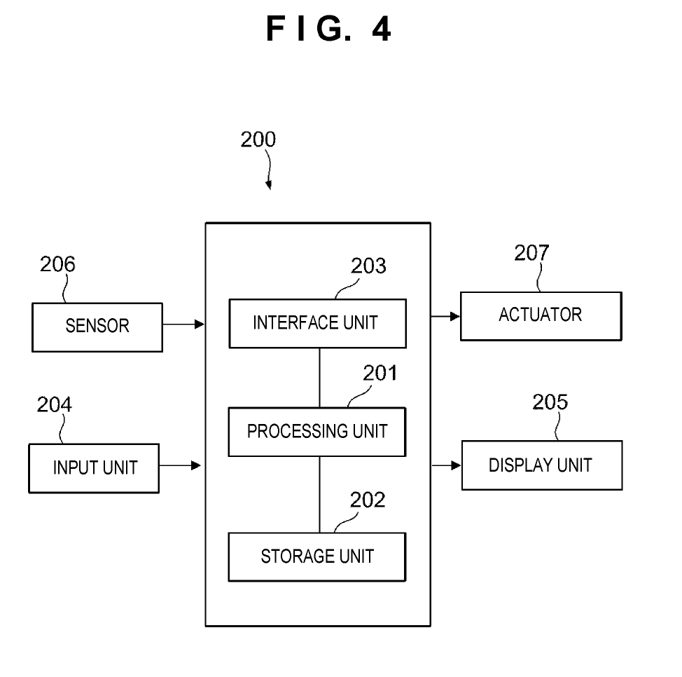

A controller 200 which controls the cutting apparatus A will be described next. FIG. 4 is a block diagram of the controller 200. The controller 200 includes a processing unit 201 such as a CPU, a storage unit 202 such as a RAM, ROM, or hard disk, and an interface unit 203 which interfaces the processing unit 201 with an external device.

The processing unit 201 executes programs based on the cutting start position and cutting end position of the moving body 21, the pivot angle of each cutting unit 30, the cutting start position and cutting end position of the head unit 3, and the like, which are stored in the storage unit 202, and controls various types of actuators 207 based on the detection results obtained by various types of sensors 206. The various types of sensors 206 include, for example, a sensor which detects the position of the head unit 3 in the Y direction, sensors which detect the pivot angles of the cutting units 30 and their positions in the Z direction, a sensor which detects the position of the substrate B conveyed by the convey unit 8, and sensors which detect the positions of the holding units 1 (moving body 21) in the X direction.

The various types of actuators 207 include a vacuum pump and control valves which actuate the vacuum-chucking pads 10, drive sources such as the motors of moving mechanisms of the moving units 2 and 4, motors which rotate the disc blades 30a, a drive source for the positioning unit 7, the motors 53 of the convey/lifting units 5, and drive sources for the substrate lifting units 6. An input unit 204 includes a keyboard and a mouse which accept instructions from an operator. A display unit 205 is an image display device which displays various kinds of information.

<Example of Operation>

The operation of cutting the edge portions of a cover sheet by the cutting apparatus A will be described next with reference to FIGS. 5 to 13. First of all, the substrate B to be processed is conveyed to the convey unit 8 by convey equipment (not shown), and is transferred from the convey unit 8 to the holding units 1. FIGS. 5 to 7 show the operation of the cutting apparatus A when transferring the substrate B covered by the cover sheet b from the convey unit 8 to the holding units 1.

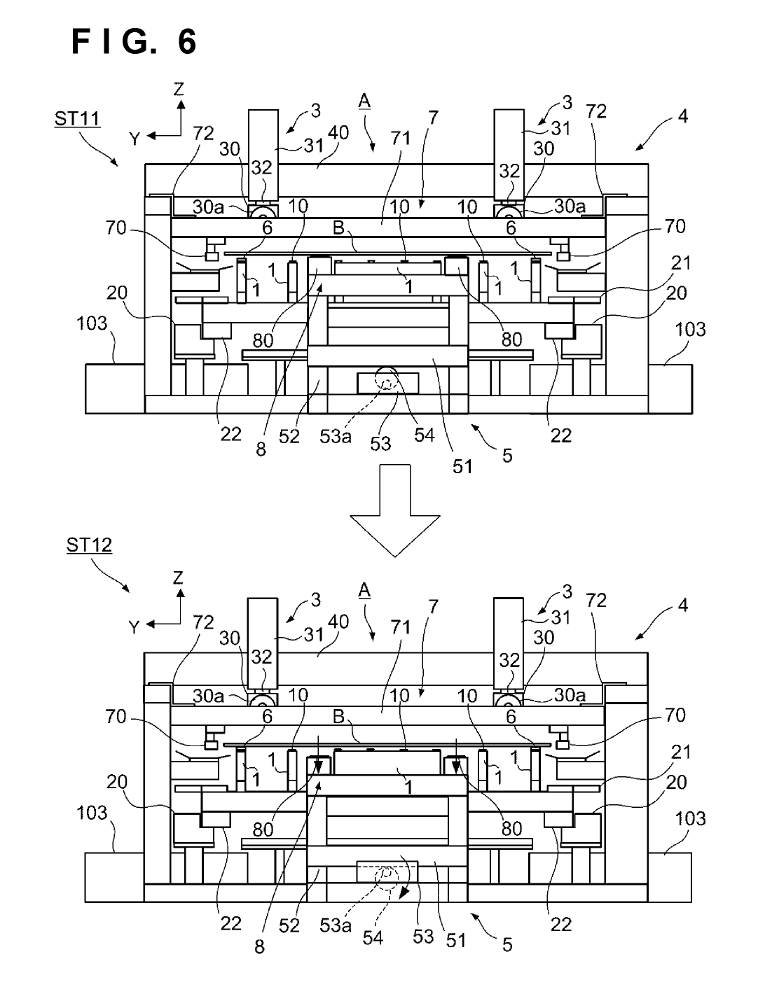

As indicated by a state ST1 in FIG. 5, the apparatus drives the convey unit 8 to convey the substrate B in the X direction to convey it onto the holding units 1 located at the load position. At this time, as indicated by a state ST11 in FIG. 6, the belt conveyors 80 of the convey unit 8 are located at the position at which they are lifted by the convey/lifting unit 5. The substrate lifting units 6 have also moved upward to a position which is lower than the substrate B but is higher than the vacuum-chucking pads 10.

When the substrate B arrives on the holding units 1, the apparatus stops driving the convey unit 8. As indicated by a state ST12 in FIG. 6, the apparatus then lowers the belt conveyors 80 of the convey unit 8 using the convey/lifting unit 5. With this operation, the apparatus transfers the substrate B from the belt conveyors 80 to the substrate lifting units 6.

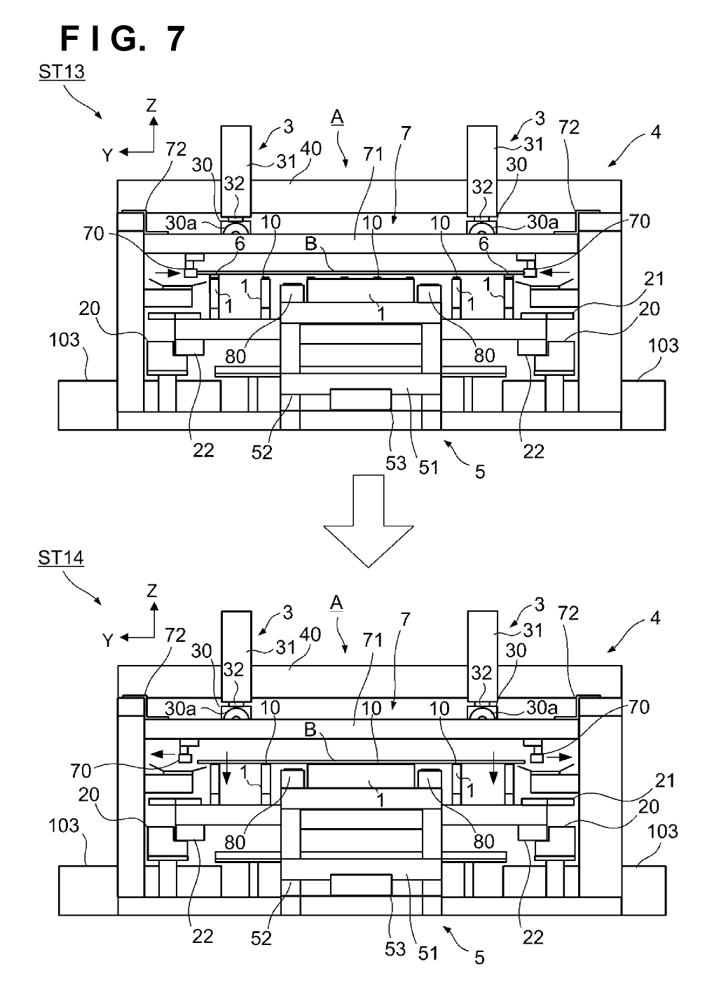

Subsequently, as indicated by a state ST13 in FIG. 7, the apparatus operates the positioning unit 7 to move the pair of abutment members 70 from the retreat position to the positioning position (a direction to approach each other in FIG. 7). This positions the substrate B. As indicated by a state ST14 in FIG. 7, the apparatus then operates the positioning unit 7 to move the pair of abutment members 70 from the positioning position to the retreat position (a direction to separate from each other in FIG. 7), and operates the substrate lifting units 6 to lower the substrate B. This moves the substrate B from the substrate lifting units 6 onto the vacuum-chucking pads 10 of the holding units 1. The apparatus operates the respective vacuum-chucking pads 10 to hold the substrate B by chucking.

The process then shifts to the operation of cutting the edge portions of the cover sheet b. The apparatus cuts the edge portions in the order of one side of the substrate B at one end portion in the X direction, two sides of two end portions in the Y direction, and one side of the other end portion in the X direction.

When cutting an edge portion of the cover sheet b which corresponds to one side of one end portion of the substrate B in the X direction, first of all, the apparatus moves the substrate B to a predetermined position (the first cutting position) using the moving unit 2 to position the disc blade 30a of the cutting unit 30 to one side of the substrate B. In addition, the apparatus sets the position and direction (the first cutting start position) of the disc blade 30a in the Y and Z directions. It is possible to store, in the storage unit 202, various kinds of information necessary for control, which include these positions and directions, based on test results before control operation (for example, teaching results) and to perform control in accordance with the stored contents.

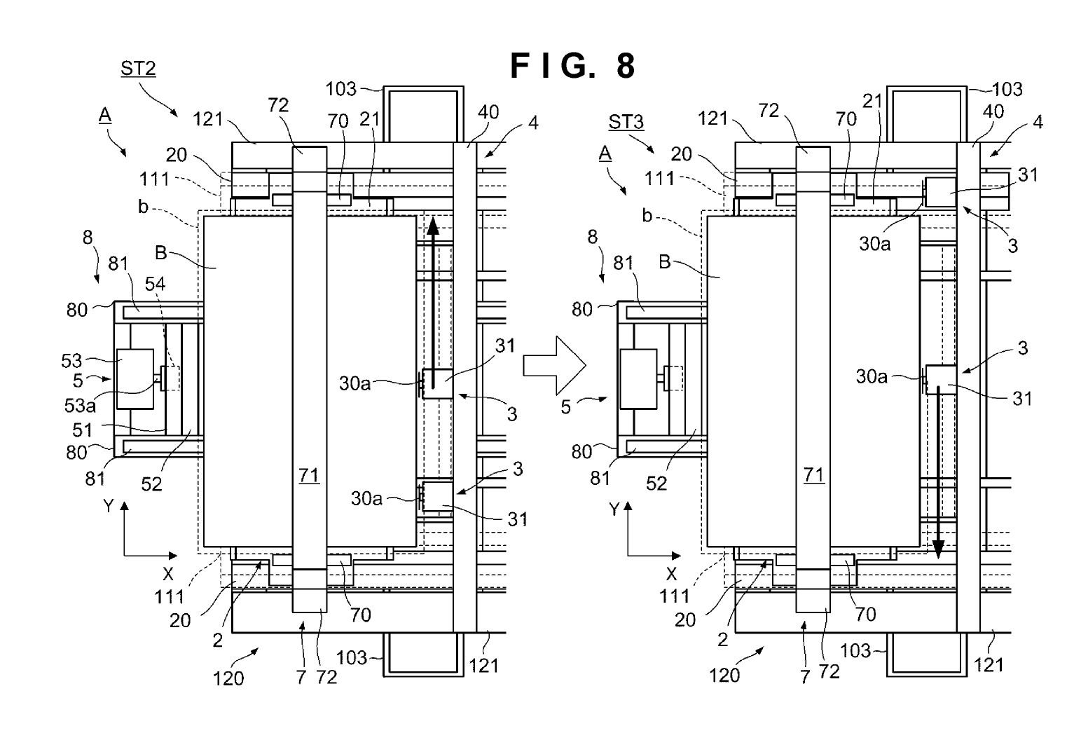

Subsequently, the apparatus cuts the edge portion of the cover sheet b. States ST2 and ST3 in FIG. 8 indicate a state in which the apparatus moves the cutting unit 30 along one side (the right side in FIG. 8) of one end portion of the substrate B in the X direction to cut an edge portion of the cover sheet b. In this embodiment, first of all, one of the two cutting units 30 cuts the edge portion of the cover sheet b along half of one side of the substrate B. More specifically, as indicated by a state ST2 in FIG. 8, the apparatus positions one cutting unit 30 at the middle position (the first cutting start position) of one side of the substrate B. The apparatus moves the cutting unit 30 from this position in the direction indicated by the arrow in FIG. 8 (the upward direction in the state ST2 in FIG. 8) to cut the edge portion. At this time, the other cutting unit 30 is made to retreat to a proper position (a retreat position). The collection unit 100 collects the cut piece.

As indicated by a state ST3 in FIG. 8, the apparatus then positions the other cutting unit 30 to the middle position of one side of the substrate B, and moves the cutting unit 30 in the direction indicated by the arrow in FIG. 8 (in the downward direction in the state ST3 in FIG. 8), thereby cutting the remaining edge portion. At this time, one cutting unit 30 is made to retreat to a proper position. With the above operation, the apparatus completes the cutting of the edge portion of the cover sheet b which corresponds to one side of one end portion of the substrate B in the X direction.

The apparatus then cuts the edge portions of the cover sheet b which correspond to the two sides of the two end portions of the substrate B in the Y direction. In this embodiment, the two cutting units 30 simultaneously cut the respective edge portions of the cover sheet b which correspond to the two sides of the two end portions in the Y direction. The apparatus cuts the edge portions from the middle position of each of the two sides of the two end portions of the substrate B in the Y direction toward one end, and then from the middle position to the other end.

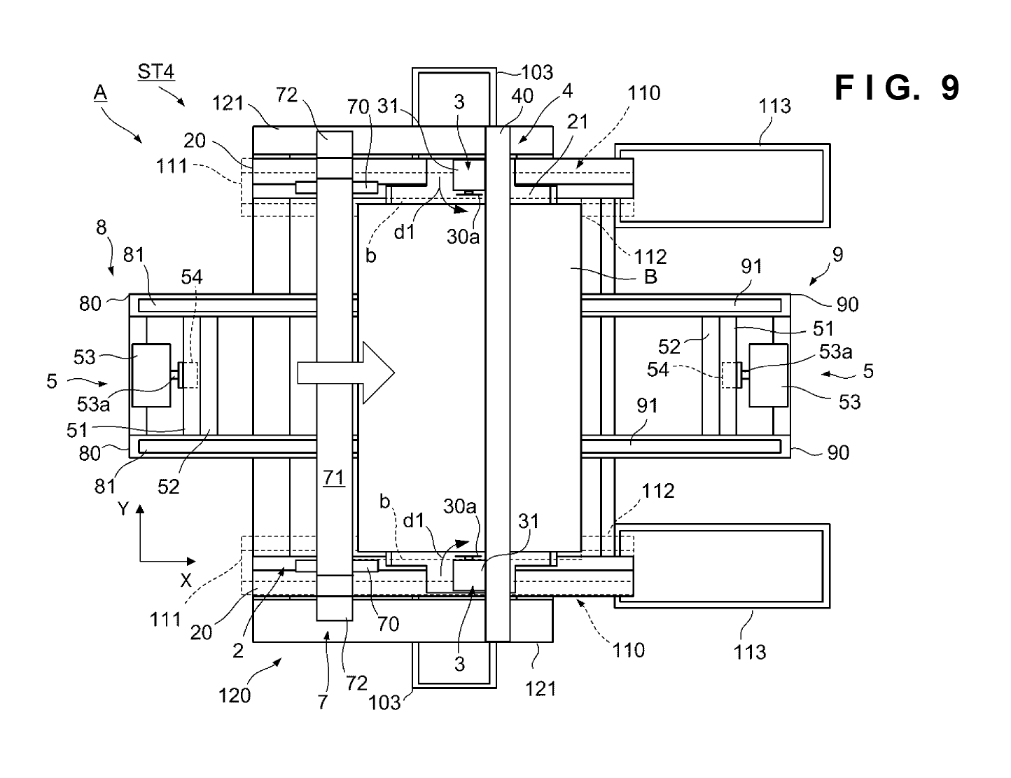

First of all, as indicated by a state ST4 in FIG. 9, therefore, the moving unit 2 moves the holding units 1 in the X direction to position the two cutting units 30 at the middle positions (the second cutting position) of the two sides of the two end portions of the substrate B in the Y direction. When moving the holding units 1, the apparatus makes the cutting units 30 retreat to proper positions (positions at which they can operate), for example, move the cutting units 30 upward, so as not to make them interfere with the substrate B.

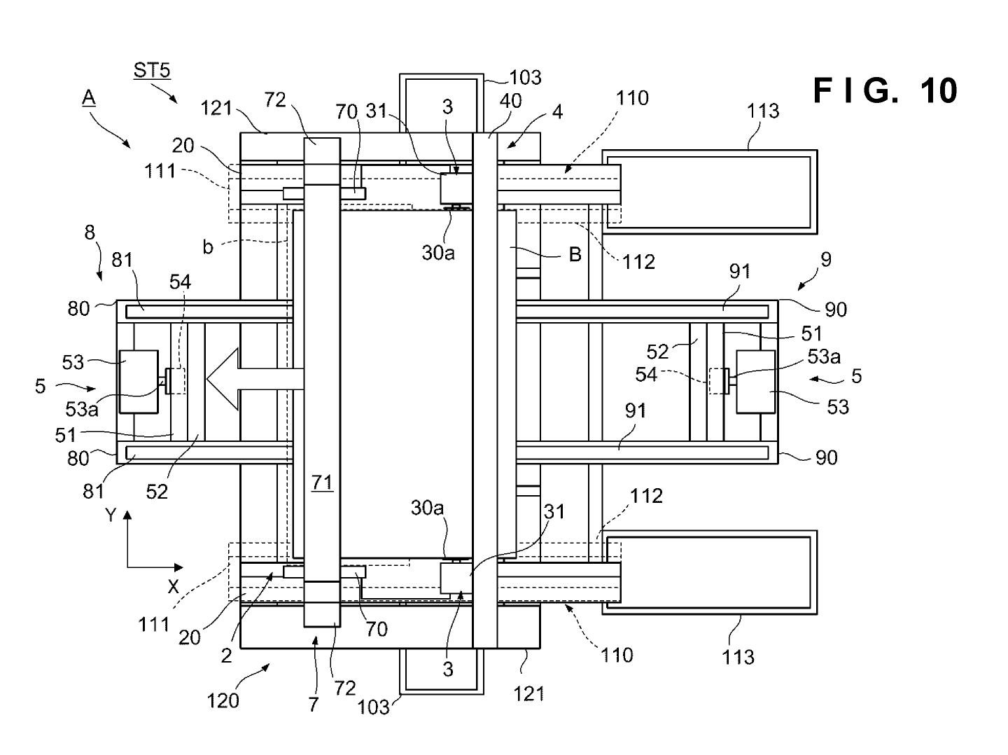

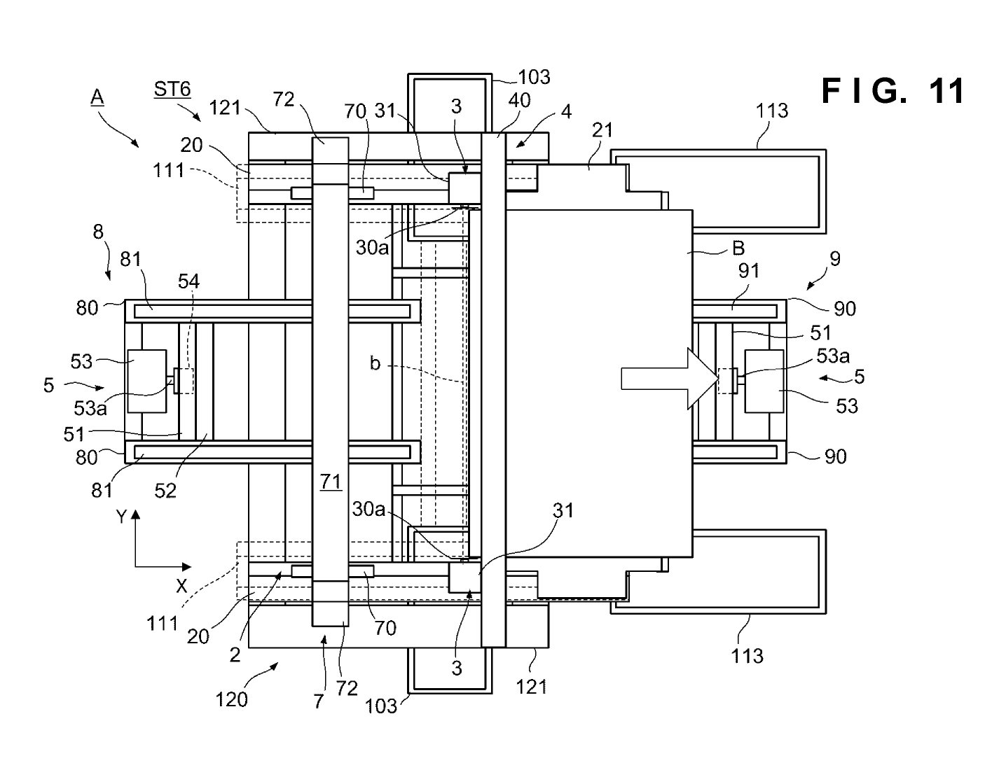

Subsequently, the apparatus makes the cutting unit 30 pivot to change the cutting direction as indicated by an arrow d1, and positions the cutting unit 30 to a predetermined position (the second cutting start position) to start cutting an edge portion of the cover sheet b. First of all, as indicated by a state ST5 in FIG. 10, the apparatus cuts half of the edge portion of the cover sheet b while moving the holding units 1 to the convey unit 8 side in the X direction using the moving unit 2. The collection unit 110 collects the cut piece. Subsequently, as indicated by a state ST6 in FIG. 11, the apparatus makes the cutting unit 30 pivot to change the cutting direction. After changing the cutting direction, the apparatus cuts the remaining half of the edge portion of the cover sheet b while moving the holding units 1 to the convey unit 9 side in the X direction using the moving unit 2. With the above operation, the apparatus completes the cutting of the edge portions of the cover sheet b which correspond to the two sides of the two end portions of the substrate B in the Y direction.

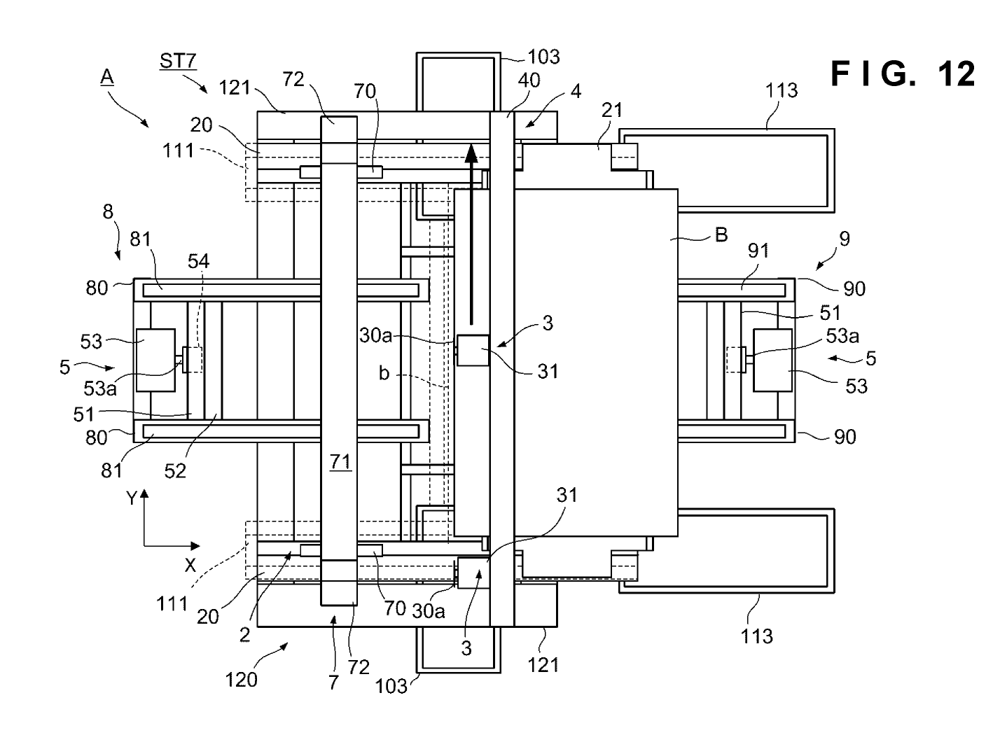

The apparatus then cuts the edge portion of the cover sheet b which corresponds to one side (the left side in FIG. 12) of the other end portion of the substrate B in the X direction. As in the case of cutting on one side of one end portion in the X direction, first of all, the apparatus moves the substrate B to a predetermined position (the third cutting position) using the moving unit 2 so as to position one side of the substrate B to the disc blade 30a of the cutting unit 30. Subsequently, the apparatus makes the cutting unit 30 pivot to change the cutting direction, and positions it to a predetermined position (the third cutting start position). As indicated by a state ST7 in FIG. 12, first of all, one of the two cutting units 30 cuts the edge portion of the cover sheet b from the middle position to one end (upward in FIG. 12) along half of one side of the substrate B. Thereafter, the other of the two cutting units 30 cuts the remaining half of the edge portion of the cover sheet b from the middle position to the other end. The collection unit 100 collects the cut piece. With the above operation, the apparatus completes the cutting of the edge portion of the cover sheet b which corresponds to one side of the other end portion of the substrate B in the X direction, thereby completing the cutting of the edge portions of the cover sheet b which correspond to all the four sides of the substrate B.

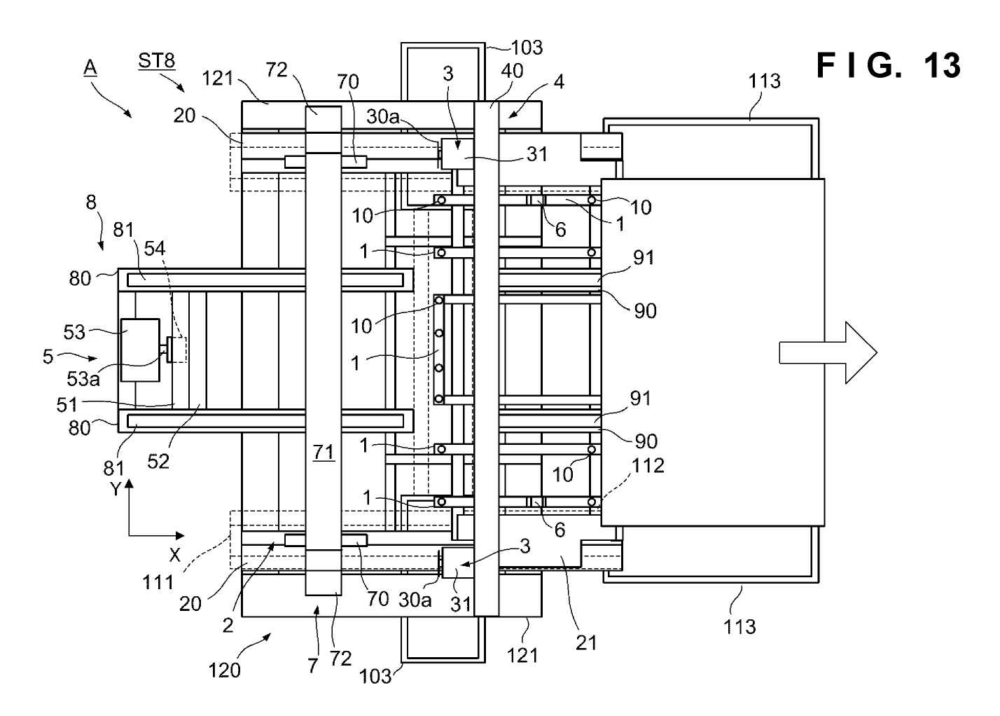

The process then shifts to unloading operation for the substrate B. The moving unit 2 moves the substrate B to the unload position and releases the holding of the substrate B by the vacuum-chucking pads 10. The convey/lifting unit 5 provided on the convey unit 9 then raises the belt conveyors 90 from the lowered position. This transfers the substrate B from the holding units 1 to the belt conveyors 90. Thereafter, as indicated by a state ST8 in FIG. 13, the apparatus drives the belt conveyors 90 to convey the substrate B in the X direction and transfer it to convey equipment or the like (not shown).

With the above operation, the apparatus completes cutting operation for one unit. This embodiment can not only move the substrate B from the convey unit 8 to a position suitable for cutting the cover sheet b by using the moving unit 2 but also can relatively move the cutting units 30 and the substrate B in the X direction when cutting the edge portions of the cover sheet b which correspond to the two sides of the two end portions of the substrate B in the Y direction. This makes it unnecessary to use a mechanism for moving the cutting units 30 in the X direction, and can cut a cover sheet along the four sides of a rectangular substrate with a simpler arrangement. In addition, it is possible to cut the edge portions of the cover sheet b in the process of transferring the substrate B from the convey unit 8 to the convey unit 9, thereby improving the operation efficiency.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-036308, filed Feb. 22, 2011, which is hereby incorporated by reference herein in its entirety.

What is claimed is:

1. A cutting apparatus which cuts an edge portion of a cover sheet covering a rectangular substrate, comprising:
a holding unit which holds the rectangular substrate by chucking one surface of the rectangular substrate;
a head unit including a cutting unit which cuts an edge portion of the cover sheet and a pivot unit which makes the cutting unit pivot to change a cutting direction;
a first moving unit which moves said head unit in a first direction parallel to one side of the rectangular substrate; and
a second moving unit which moves said holding unit in a second direction parallel to the other side perpendicular to the one side of the rectangular substrate, and moves said holding unit across a transfer position of the rectangular substrate and a cutting operation region which are continuous in the second direction.

2. The apparatus according to claim 1, further comprising a convey unit which performs at least one of loading of the rectangular substrate to said holding unit and unloading of the rectangular substrate from said holding unit at the transfer position.

3. The apparatus according to claim 2, further comprising a lifting unit which relatively moves said holding unit and said convey unit vertically at the transfer position.

4. The apparatus according to claim 1, wherein the transfer position includes a load position at which the rectangular substrate is loaded to said holding unit, and
the apparatus further comprises a positioning unit which positions the rectangular substrate in the first direction at the load position.

5. The apparatus according to claim 1, wherein said first moving unit is disposed so as to be vertically shifted from said holding unit in a range in which said holding unit is moved by said second moving unit.

6. The apparatus according to claim 5, wherein said second moving unit comprises
a pair of guide members which are spaced apart from each other in the first direction and extend in the second direction,
a moving body which is laid between said pair of guide members and supports said holding unit, and
a moving mechanism which moves said moving body along said pair of guide members.

7. The apparatus according to claim 5, wherein said first moving unit comprises
a guide member which extends in the first direction,
a moving body which is attached to said guide member so as to be movable along said guide member and supports said head unit, and
a moving mechanism which moves said moving body along said guide member.

8. The apparatus according to claim 5, wherein said first moving unit comprises
a first guide member which extends in the first direction,
a first moving body which is attached to said first guide member so as to be movable along said first guide member and supports said head unit, and
a first moving mechanism which moves said first moving body along said first guide member,
said second moving unit comprises
a pair of second guide members which are spaced apart from each other in the first direction and extend in the second direction,
a second moving body which is laid between said pair of second guide members and supports said holding unit, and
a second moving mechanism which moves said second moving body along said pair of second guide members, and
said first guide member is vertically spaced apart from and intersects said pair of second guide members.

9. The apparatus according to claim 8, further comprising
a first collection unit which extends in the first direction below a moving path of said cutting unit along said first guide member and collects a cut edge portion of the cover sheet, and
a pair of second collection units which extend in the second direction along said pair of second guide members below said cutting unit and collect cut edge portions of the cover sheet.

10. The apparatus according to claim 7, wherein two sets, each comprising said head unit, said moving body, and said moving mechanism are provided, and
each of said two moving bodies is attached to said common guide member.

11. The apparatus according to claim 9, further comprising a frame member which integrally supports said pair of second guide members, said first guide member, said first collection unit, and said second collection unit.

12. The apparatus according to claim 1, wherein the transfer position includes a load position at which the rectangular substrate is loaded to said holding unit at one end of the cutting operation region in the second direction, and an unload position at which the rectangular substrate is unloaded from said holding unit at the other end of the cutting operation region in the second direction.
